(19) United States
(12) Patent Application Publication
(10) Pub. No.: US 2020/0095469 A1
(43) Pub. Date: Mar. 26, 2020

(54) OPTICAL LAMINATE AND FLEXIBLE DISPLAY COMPRISING THE SAME

(71) Applicant: DONGWOO FINE-CHEM CO., LTD., Iksan-si, Jeollabuk-do (KR)

(72) Inventors: Byung Muk YU, Pyeongtaek-si (KR); Daesan KANG, Seoul (KR); Jongkwan LIM, Hwaseong-si (KR)

(73) Assignee: DONGWOO FINE-CHEM CO., LTD., Iksan-si, Jeollabuk-do (KR)

(21) Appl. No.: 16/612,043

(22) PCT Filed: May 4, 2018
(86) PCT No.: PCT/KR2018/005180

§ 371 Date: Nov. 8, 2019

(30) Foreign Application Priority Data
May 10, 2017 (KR) 10-2017-0058320

(51) Int. Cl. C09J 7/29; G02B 5/30; C09J 7/38

(52) U.S. Cl. CPC C09J 7/29; C09J 2201/622; C09J 7/38; G02B 5/30

(57) ABSTRACT

Provided are an optical laminate comprising a cover window, a decoration layer, and a pressure-sensitive adhesive layer, wherein the pressure-sensitive adhesive layer has a step height follow-up factor (Y) of 1 or more, and a flexible display comprising the optical laminate. The optical laminate has excellent step height follow-up property, thereby allowing the occurrence of bubbles to be suppressed in the step height part, and has excellent bending resistance under high-temperature high-humidity condition, and thus it can be effectively used for a flexible display.

### TECHNICAL FIELD

The present invention relates to an optical laminate and a flexible display comprising the same. More particularly, the present invention relates to an optical laminate which has excellent step height follow-up property, thereby allowing the occurrence of bubbles to be suppressed in a step height part, and has excellent bending resistance under high-temperature high-humidity condition, and a flexible display comprising the same.

### BACKGROUND ART

Among pressure-sensitive adhesives, an optically clear adhesive (OCA) having high transparency has been used for interlayer adhesion to laminate components in a display device. Such optically clear adhesive should have high transmission and low haze and satisfy properties such as adhesion with various substrates, heat resistance and humidity-heat resistance.

Recently, a flexible display device which can maintain display performance even when it is bent like a paper using a flexible cover window gains attention as a next generation display device. In this regard, a development for an optically clear adhesive having excellent adhesion property in the bent or folded portion and good durability has been required. In addition, a need for a smartphone and tablet PC has been remarkably increased, and thus a technical development for an optically clear adhesive for attaching a cover window having a decoration layer formed thereon to lower optical layers such as a polarizing plate or touch sensor has been required. Particularly, since such decoration layer has a step height, there has been required a technical development for an optically clear adhesive which has excellent step height follow-up property (filling-up property) when it is applied to attaching the decoration layer, thereby allowing the occurrence of bubbles to be suppressed in the step height part.

Korean Patent Application Publication No. 2016-0140749 discloses that a pressure-sensitive adhesive having a gel fraction of 40 to 90% and formed by crosslinking a pressure-sensitive adhesive composition having a (meth)acrylic ester polymer, a crosslinking agent, and a crosslinking accelerator, wherein the (meth)acrylic ester polymer has a weight average molecular weight of 200,000 to 900,000 and contains a hydroxyl group-containing monomer in an amount of more than 10 wt % and 30 wt % or less as a monomer unit composing the polymer, has step height follow-up property and can allow the occurrence of bubbles to be suppressed.

However, when such pressure-sensitive adhesive is used to attach a cover window on which a decoration layer is formed to lower optical layers such as a polarizing plate or touch sensor, bending resistance is lowered under high-temperature high-humidity condition, and thus there are difficulties in applying it to a flexible display. Therefore, there has been required a development for an optical laminate which has excellent step height follow-up property, thereby allowing the occurrence of bubbles to be suppressed in a step height part, and has excellent bending resistance under high-temperature high-humidity condition.

### DISCLOSURE

### Technical Problem

It is an object of the present invention to provide an optical laminate which has excellent step height follow-up property, thereby allowing the occurrence of bubbles to be suppressed in a step height part, and has excellent bending resistance under high-temperature high-humidity condition.

It is another object of the present invention to provide a flexible display comprising the optical laminate.

### Technical Solution

In accordance with one aspect of the present invention, there is provided an optical laminate comprising a cover window, a decoration layer, and a pressure-sensitive adhesive layer, wherein the pressure-sensitive adhesive layer has a step height follow-up factor (Y) defined by the following mathematical formula 1 of 1 or more:

step height follow-up factor (Y)=(a/b)×c [Mathematical Formula 1]

wherein,

a represents a thickness of the pressure-sensitive adhesive layer,

b represents a step height of the decoration layer, and

c represents a stress relaxation parameter of the pressure-sensitive adhesive layer, which is defined by [0.1 sec G(t)−300 sec G(t)]/0.1 sec G(t).

In one embodiment of the present invention, the pressure-sensitive adhesive layer may have an adhesive force of 5 N/25 mm or more to an adherend.

In one embodiment of the present invention, the adherend may be corona-treated, plasma-treated, or primer-treated.

In one embodiment of the present invention, the pressure-sensitive adhesive layer may be corona-treated or plasma-treated.

In accordance with another aspect of the present invention, there is provided a flexible display comprising the optical laminate.

In one embodiment of the present invention, the flexible display may further comprise an optical layer laminated on the surface of the pressure-sensitive adhesive layer of the optical laminate.

### Advantageous Effects

The optical laminate according to the present invention comprising the cover window, the decoration layer, and the pressure-sensitive adhesive layer has excellent adhesive force to lower optical layers such as a polarizing plate or touch sensor, has excellent follow-up property (filling-up property) for the step height caused by the decoration layer, thereby allowing the occurrence of bubbles to be suppressed in the step height part, and has excellent bending resistance under high-temperature high-humidity condition, and thus it can be effectively used for a flexible display.

### BRIEF DESCRIPTION OF THE DRAWINGS

FIG. 1 is a cross-sectional view schematically illustrating the flexible display according to one embodiment of the present invention.

FIG. 2 is a cross-sectional view schematically illustrating the flexible display according to another embodiment of the present invention.

### BEST MODE

Hereinafter, the present invention will be described in more detail.

One embodiment of the present invention relates to an optical laminate comprising a cover window, a decoration layer, and a pressure-sensitive adhesive layer, wherein the pressure-sensitive adhesive layer has a step height follow-up factor (Y) defined by the following mathematical formula 1 of 1 or more:

step height follow-up factor (Y)=(a/b)×c [Mathematical Formula 1]

wherein,

a represents a thickness of the pressure-sensitive adhesive layer,

b represents a step height of the decoration layer, and

c represents a stress relaxation parameter of the pressure-sensitive adhesive layer, which is defined by [0.1 sec G(t)−300 sec G(t)]/0.1 sec G(t).

The step height of the decoration layer means a difference by height of the decoration layer formed on the cover window.

The stress relaxation parameter means a value of a difference between an initial stress and a stress after time t divided by the initial stress, when a given shear stress is applied to an object. Accordingly, the stress relaxation parameter of the pressure-sensitive adhesive layer, which is defined by [0.1 sec G(t)−300 sec G(t)]/0.1 sec G(t), is a value of a stress after 300 seconds (300 sec G(t)) subtracted from an initial stress (0.1 sec G(t)), divided by the initial stress (0.1 sec G(t)).

The stress relaxation parameter of the pressure-sensitive adhesive layer, which is defined by [0.1 sec G(t)−300 sec G(t)]/0.1 sec G(t), can be obtained by measurement according to the following method. A pressure-sensitive adhesive layer-forming composition is coated on a release film and cured to form a pressure-sensitive adhesive layer having a thickness of 150 m, and then the pressure-sensitive adhesive layer is separated from the release film to prepare a circular sample having a diameter of 8 mm. Thereafter, using rheometer (for example, MCR-301 from Anton Paar GmbH) set up to 10% strain, an initial modulus (0.1 sec G(t)) of the sample is measured at room temperature, and then modulus after standing at room temperature for 300 seconds (300 sec G(t)) is measured to obtain the stress relaxation parameter of the pressure-sensitive adhesive layer.

The optical laminate according to one embodiment of the present invention comprises the pressure-sensitive adhesive layer having a step height follow-up factor (Y) of 1 or more, for example 1 to 50, particularly 1 to 20, so that it has excellent step height follow-up property, thereby allowing the occurrence of bubbles to be suppressed in the step height part, and has excellent bending resistance under high-temperature high-humidity condition. If the step height follow-up factor (Y) is less than 1, the step height follow-up property can be lowered, which may result in the occurrence of bubbles in the step height part, or the bending resistance can be lowered under high-temperature high-humidity condition. If the step height follow-up factor (Y) exceeds 50, flexibility can be lowered or cohesive force of the pressure-sensitive adhesive can be insufficient, and thus bubbles may occur in reliability evaluation.

### Cover Window

In one embodiment of the present invention, the cover window may be a hard coating film or a glass substrate.

The hard coating film may comprise a transparent substrate and a hard coating layer formed on at least one surface of the transparent substrate.

As the transparent substrate, any plastic film can be used as long as it has transparency. For example, it may be formed of polymers such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinyl alcohol, polyvinyl acetal, polyether ketone, polyether ether ketone, polyether sulfone, polymethyl metacrylate, polyethylene terephthalate, polybutylene terephthalate, polyethylene naphthalate, polycarbonate, etc. These polymers can be used alone or in combination of two of more.

The thickness of the transparent substrate is not particularly limited, but may be 10 to 500 μm, particularly 20 to 150 μm. If the thickness of the transparent substrate is less than 10 μm, the strength of the film is lowered, thereby having low workability. If the thickness exceeds 500 μm, there may arise the problems of low transparency or low bending property.

The hard coating layer may be formed from a hard coating composition comprising a photocurable epoxy resin and a photopolymerization initiator.

The photocurable epoxy resin may include an alkoxysilane compound or polysiloxane resin having an epoxy group.

The alkoxysilane compound having an epoxy group may include a compound of the following chemical formula 1:

R¹ₙSi(OR²)₄₋ₙ [Chemical Formula 1]

wherein, R¹ is an epoxy group, R² is a C₁-C₂₀ alkyl group, and n is an integer of 1 to 3.

The C₁-C₂₀ alkyl group as used herein refers to a linear or branched hydrocarbon having 1 to 20 carbon atoms, and examples thereof include methyl, ethyl, n-propyl, i-propyl, n-butyl, i-butyl, t-butyl, n-pentyl, n-hexyl, and the like, but are not limited thereto.

The alkoxysilane compound having an epoxy group carries out cationic photopolymerization by an epoxy group. The cationic photopolymerization shows relatively low shrinkage rate, and allows stable curing and has excellent curing rate since oxygen inhibition reaction does not occur on the surface. Also, the polysiloxane resin formed by sol-gel reaction of the alkoxysilane compound has a siloxane network, thereby having characteristics of fast cationic photopolymerization and excellent curing rate. Such alkoxysilane compound and polysiloxane resin having an epoxy group impart excellent hardness as well as excellent flexibility to the hard coating composition.

The alkoxysilane compound having an epoxy group of the chemical formula 1 may be selected from the group consisting of 2-(3,4-epoxycyclohexyl)ethyltrimethoxysilane, 2-(3,4-epoxycyclohexyl)ethyltriethoxysilane, 3-glycidoxypropyltrimethoxysilane, and 3-glycidoxypropyltriethoxysilane.

The polysiloxane resin having an epoxy group may be formed by a hydrolytic sol-gel reaction of the alkoxysilane compound.

Specifically, an alkoxy group of the alkoxysilane which is a starting material is hydrolyzed with water to form a hydroxyl group, which performs a condensation reaction with an alkoxy group or hydroxyl group of another alkoxysilane compound to form a siloxane bond, thereby forming a polysiloxane.

Preferably, a catalyst can be added in order to accelerate the hydrolytic sol-gel reaction. Examples of the catalyst which can be used may include an acid catalyst such as acetic acid, phosphoric acid, sulfuric acid, hydrochloric acid, nitric acid, chlorosulfonic acid, para-toluic acid, trichloroacetic acid, polyphosphoric acid, pyrophosphoric acid, iodic acid, tartaric acid, and perchloric acid; a base catalyst such as ammonia, sodium hydroxide, n-butylamine, di-n-butylamine, tri-n-butylamine, imidazole, ammonium perchlorate, potassium hydroxide, and barium hydroxide; or an ion exchange resin such as Amberite IPA-400(Cl). The amount of the catalyst is not particularly limited, and may be 0.0001 to 10 parts by weight based on 100 parts by weight of the alkoxysilane.

The hydrolytic sol-gel reaction can be carried out by stirring at room temperature for 6 to 144 hours, and can be carried out at 60 to 80° C. for 6 to 36 hours in order to accelerate the reaction rate and complete the condensation reaction.

The photopolymerization initiator is used for photocuring of the hard coating composition, and may be used without limitation as long as it is an initiator which can be used in the art.

As the photopolymerization initiator, cationic photopolymerization initiator which generates cation species or Lewis acids by irradiation of active energy rays such as visible light, UV ray, X-ray, or electron beam, thereby capable of initiating the polymerization of the cationic photocurable components may be used.

Since the cationic photopolymerization initiator acts catalytically by light, it has excellent storage stability or workability even if it is mixed with the cationic photocurable components. As the compounds generating cation species or Lewis acids by irradiation of the active energy rays, onium salts such as aromatic diazonium salt, aromatic iodonium salt, or aromatic sulfonium salt; Fe-allene complex, etc. may be exemplified. Among these, the aromatic sulfonium salt is preferable, since it has UV absorption property even in the wavelength region near 300 nm, thereby having good curability and imparting excellent film property. The cationic photopolymerization initiators can be used alone or in combination of 2 or more.

The photopolymerization initiator may be contained in an amount of 0.1 to 5 parts by weight based on 100 parts by weight of the photocurable epoxy resin. If the amount of the photopolymerization initiator is less than 0.1 parts by weight, the curing rate may be low. If the amount of the photopolymerization initiator exceeds 5 parts by weight, cracks may occur in the hard coating layer due to excessive curing.

The hard coating composition may further comprise a reactive monomer having an alicyclic epoxy group, glycidiyl group, or oxetane group.

As the reactive monomer, diglycidyl ether and the like can be used.

The reactive monomer may be contained in an amount of 5 to 30 parts by weight based on 100 parts by weight of the photocurable epoxy resin.

The hard coating composition may further comprise a solvent if necessary.

The solvent may be used without limitation as long as it is a solvent used in the art. Specific examples thereof may include alcohols such as methanol, ethanol, isopropanol, butanol, and propyleneglycol methoxy alcohol; ketones such as methylethylketone, methylbutylketone, methylisobutylketone, diethylketone, and dipropylketone; acetates such as methyl acetate, ethyl acetate, butyl acetate, and propyleneglycol methoxy acetate; cellosolves such as methyl cellosolve, ethyl cellosolve, and propyl cellosolve; hydrocarbons such as n-hexane, n-heptane, benzene, toluene, and xylene. The solvents can be used alone or in combination of 2 or more.

The hard coating composition may be coated on the transparent substrate by suitably using a known coating process such as die coater, air knife, reverse roll, spray, blade, casting, gravure, micro gravure, or spin coating.

After the hard coating composition is coated on the transparent substrate, it is cured by irradiation of UV rays. The irradiation intensity of UV rays may be 0.1 to 6,000 mW/cm². The transparent substrate may be surface-treated by corona, etc. before being coated.

Also, the photocuring may be followed by additional heat treatment. The heat treatment may be carried out at the temperature of approximately 50° C. or more under relative humidity of approximately 50% or more (absolute humidity of 41 g/m³ or more).

At this time, the thickness of the hard coating layer to be formed may be particularly 5 to 200 μm, more particularly 5 to 100 μm. When the thickness of the hard coating layer is in the above range, impact resistance is excellent, and bending performance is improved due to suitable thickness.

### Decoration Layer

In one embodiment of the present invention, the decoration layer provides a decorative element and prevents lower parts such as electrode wiring of a touch sensor from being seen.

The decoration layer may comprise bezel, logo, icon, camera window, infrared ray window, etc.

The decoration layer may be formed by a printing method using an ink in which an organic or inorganic pigment, a solvent, a dispersing agent, a binder, etc. are mixed. The printing may be carried out by using a printing apparatus such as an inkjet printer or a silkscreen printer. Also, the decoration layer may be formed by imprinting an organic material pattern, performing thin film deposition followed by photolithography, or performing lithography of colored photoresist (PR).

The decoration layer may have a thickness of 1 μm to 30 μm. If the thickness of the decoration layer is less than 1 μm, there may be problems that light-shielding property may be lowered, or color becomes faint and thus the true color does not appear. If the thickness exceeds 30 μm, there may be a problem that the thickness of the pressure-sensitive adhesive becomes too thick in order to fill up the step height.

### Pressure-Sensitive Adhesive Layer

In one embodiment of the present invention, the pressure-sensitive adhesive layer may consist of a pressure-sensitive adhesive composition for an optical laminate which is known in the art.

The pressure-sensitive adhesive composition may comprise an acryl-based copolymer and a crosslinking agent.

The acryl-based copolymer may be a copolymer of a (meth)acrylate monomer having an alkyl group of 1 to 12 carbon atoms and a polymerizable monomer having a crosslinkable functional group. Herein, the (meth)acrylate refers to acrylate and methacrylate.

Specific examples of the (meth)acrylate monomer having an alkyl group of 1 to 12 carbon atoms include n-butyl (meth)acrylate, isobutyl (meth)acrylate, t-butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, nonyl (meth)acrylate, decyl (meth)acrylate, lauryl (meth)acrylate, and the like. Among these, n-butyl acrylate, 2-ethylhexyl acrylate, or a mixture thereof is preferable. They can be used alone or in combination of two or more.

The polymerizable monomer having a crosslinkable functional group is a component for reinforcing cohesive force or adhesive strength of the pressure-sensitive adhesive composition by a chemical bond, thereby imparting durability and cutability. For example, a monomer having a hydroxyl group and a monomer having a carboxyl group may be exemplified, and they can be used alone or in combination of two or more.

Examples of the monomer having a hydroxyl group include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethylene glycol (meth)acrylate, 2-hydroxypropylene glycol (meth)acrylate, hydroxyalkylene glycol (meth)acrylate having an alkylene group of 2 to 4 carbon atoms, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, and the like. Among these, 4-hydroxybutyl acrylate, 2-hydroxyethyl (meth)acrylate, 4-hydroxybutyl vinyl ether and the like are preferable.

Examples of the monomer having a carboxyl group include a monovalent acid such as (meth)acrylic acid, crotonic acid and the like; a divalent acid such as maleic acid, itaconic acid, fumaric acid and the like, and an monoalkyl ester thereof; 3-(meth)acryloyl propionic acid; a succinic anhydride ring-opening adduct of 2-hydroxyalkyl (meth)acrylate having an alkyl group of 2 to 3 carbon atoms, a succinic anhydride ring-opening adduct of hydroxyalkylene glycol (meth)acrylate having an alkylene group of 2 to 4 carbon atoms, a compound obtained by a ring-opening addition of succinic anhydride to a caprolactone adduct of 2-hydroxyalkyl (meth)acrylate having an alkyl group of 2 to 3 carbons, etc. Among these, (meth)acrylic acid is preferable.

The polymerizable monomer having a crosslinkable functional group is preferably contained in an amount of 0.05 to 10 parts by weight, more preferably 0.1 to 8 parts by weight based on 100 parts by weight of the (meth)acrylate monomer having an alkyl group of 1 to 12 carbon atoms. If the amount of the polymerizable monomer having a crosslinkable functional group is less than 0.05 parts by weight, cohesive force of the adhesive can be lowered, and thus durability may be deteriorated. If the amount exceeds 10 parts by weight, adhesive force can be lowered due to high gel fraction, and a problem may be caused in durability.

The acryl-based copolymer may further contain, in addition to the above-mentioned monomers, other polymerizable monomers within a range that does not deteriorate the adhesive force, for example, in an amount of 10% by weight or less based on the total amount.

The method for preparing the acryl-based copolymer is not particularly limited, and it can be prepared by methods which are commonly used in the art, such as bulk polymerization, solution polymerization, emulsion polymerization or suspension polymerization, and solution polymerization is preferable. Further, a solvent, a polymerization initiator, a chain transfer agent for molecular weight control, and the like, which are commonly used in polymerization, can be used.

The acryl-based copolymer commonly has a weight average molecular weight (in terms of polystyrene, Mw) measured by gel permeation chromatography (GPC) of 50,000 to 2,000,000, preferably 400,000 to 2,000,000. If the weight average molecular weight is less than 50,000, cohesive force between the copolymers may be insufficient, thereby causing a problem in adhesion durability. If the weight average molecular weight exceeds 2,000,000, a large amount of dilution solvent may be needed in order to secure process property during coating process.

The crosslinking agent is a component which can enhance adhesion property and durability, and maintain reliability at high temperature and form of the adhesive. By way of examples, the crosslinking agent may include isocyanate compounds, epoxy compounds, peroxide compounds, metal chelate compounds, oxazoline compounds, etc., and these compounds may be used alone or in combination of two or more. Among these, isocyanate compounds are preferred.

In particular, diisocyanate compounds such as tolylene diisocyanate, xylene diisocyanate, hexamethylene diisocyanate, 2,4- or 4,4-diphenylmethane diisocyanate; and adducts of polyhydric alcohol compounds such as trimethylolpropane to the diisocyanate compounds may be used.

The crosslinking agent may be contained in an amount of 0.01 to 15 parts by weight, preferably 0.01 to 5 parts by weight, based on 100 parts by weight of the acryl-based copolymer. If the amount of the crosslinking agent is less than 0.01 parts by weight, cohesive force may be lowered due to insufficient crosslinking degree, and thus adhesion durability and cutability may be deteriorated. If the amount exceeds 15 parts by weight, there may arise a problem in residual stress relaxation due to excessive crosslinking reaction.

The pressure-sensitive adhesive layer can be formed by coating the pressure-sensitive adhesive composition on an adherend, or attaching a pressure-sensitive adhesive sheet formed from the pressure-sensitive adhesive composition to the adherend.

The coating method is not particularly limited as long as it is commonly used in the art, and examples thereof may include mayer bar coating method, gravure coating method, die coating method, dip coating method, spray method, etc.

The thickness of the pressure-sensitive adhesive layer formed by the above method is not particularly limited. The thickness may be, for example, 5 to 250 μm, preferably 10 to 200 μm.

The adhesive force of the pressure-sensitive adhesive layer may be 5 N/25 mm or more, for example 5 to 40 N/25 mm, to the adherend.

Each side of the adherend and the pressure-sensitive adhesive layer to be attached may be individually treated for ease of attachment. For example, the adherend may be corona-treated, plasma-treated, or primer-treated, and the pressure-sensitive adhesive layer may be corona-treated or plasma-treated.

### Flexible Display

One embodiment of the present invention relates to a flexible display comprising the above-mentioned optical laminate.

The flexible display may further comprise an optical layer laminated on the side of the pressure-sensitive adhesive layer of the optical laminate.

The optical layer may be at least one selected from the group consisting of a polarizing plate, a touch sensor, and an anti-scattering film, but is not limited thereto.

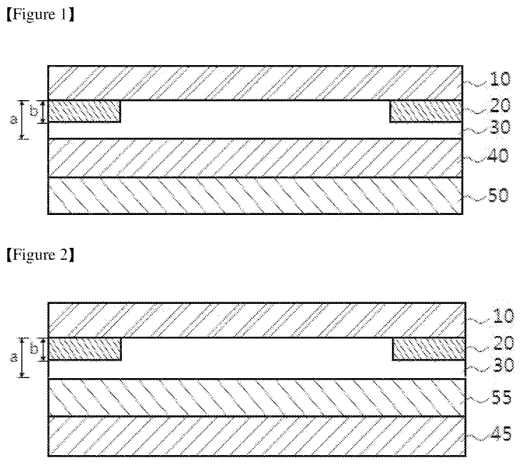

FIG. 1 is a cross-sectional view schematically illustrating the flexible display according to one embodiment of the present invention.

Referring to FIG. 1, the flexible display according to one embodiment of the present invention comprises a cover window 10, a decoration layer 20 formed under the cover window, a pressure-sensitive adhesive layer 30 formed under the decoration layer, a polarizing plate 40 formed under the pressure-sensitive adhesive layer, and a touch sensor 50 formed under the polarizing plate.

FIG. 2 is a cross-sectional view schematically illustrating the flexible display according to another embodiment of the present invention.

Referring to FIG. 2, the flexible display according to one embodiment of the present invention comprises a cover window 10, a decoration layer 20 formed under the cover window, a pressure-sensitive adhesive layer 30 formed under the decoration layer, a touch sensor 55 formed under the pressure-sensitive adhesive layer, and a polarizing plate 45 formed under the touch sensor.

In FIGS. 1 and 2, a represents a thickness of the pressure-sensitive adhesive layer 30, and b represents a step height of the decoration layer 20.

In one embodiment of the present invention, the polarizing plate 40, 45 may comprise a polarizer, and a protective film laminated on at least one side of the polarizer if necessary.

The polarizing plate may comprise an elongation-type or coating-type polarizer. Specific examples of the polarizing plate may include a polarizing plate formed by laminating a protective layer on at least one side of the polarizer in which polyvinyl alcohol film is stretched and dyed with iodine or dichroic dye, a polarizing plate formed by aligning a liquid crystal on a transparent film to have properties of a polarizer, a polarizing plate formed by coating an alignable resin such as polyvinyl alcohol on a transparent film and stretching and dyeing it, etc., but are not limited thereto.

Also, as the touch sensor 50, 55, conventional touch sensors can be used, and for example, a film touch sensor having a form of film may be used.

Hereinafter, the present invention will be described in more detail with reference to examples, comparative examples and experimental examples. It should be apparent to those skills in the art that these examples, comparative examples and experimental examples are for illustrative purpose only, and the scope of the present invention is not limited thereto.

### Preparation Example 1: Preparation of Hard Coating Film

### Preparation of Photocurable Epoxy Resin

3-Glycidoxypropyl trimethoxysilane and water were mixed in the ratio of 23.63 g:2.70 g (0.1 mol:0.15 mol), and introduced into an 100 mL 2-neck flask. Then, 0.05 mL of ammonia as a catalyst was added to the mixture followed by stirring at 60° C. for 6 hours to prepare a photocurable epoxy resin.

### Preparation of Hard Coating Composition

The photocurable epoxy resin and diglycidyl ether were mixed in the weight ratio of 100:10, and then, based on 100 parts by weight of the mixture, 2 parts by weight of triarylsulfonium hexafluoroantimonate salt was mixed therewith, to prepare a hard coating composition.

### Preparation of Hard Coating Film

The hard coating composition was coated in a thickness of 50 μm on a polyimide film having a thickness of 80 μm which was surface-treated with corona. The coated film was exposed to mercury UV (Ultra Violet) lamp (20 mW/cm²) for 5 minutes to perform photocuring by the triarylsulfonium hexafluoroantimonate salt, followed by moisture-heat treatment under the condition of 50° C. and relative humidity of 50% for 60 minutes, to prepare a hard coating film.

### Preparation Example 2: Preparation of Composition for Forming Decoration Layer

35.0g of a colorant consisting of a first white pigment having an average diameter of 200 nm as C.I. pigment white 6 and a second white pigment having a diameter size of 100 nm and refractive index of 1.57 as C.I. pigment white 24 (the amount of the second white pigment is 10 parts by weight based on 100 parts by weight of the first white pigment), 4.94 g of a binder resin (copolymer of methacrylic acid and benzylmethacrylate in which the molar ratio of the methacrylic acid unit and benzylmethacrylate unit is 31:69 and a weight average molecular weight in terms of polystyrene is 20,000), 4.32 g of BYK-180 (manufactured by BYK corporation) as a dispersing agent, and 55.74 g of propyleneglycol monomethyl ether acetate as a solvent were mixed and dispersed by bead mill for 2 hours, to prepare a colorant-dispersed composition.

50.2 g of the colorant-dispersed composition, 29.5 g of copolymer of methacrylic acid and benzylmethacrylate (the molar ratio of the methacrylic acid unit and benzylmethacrylate unit is 31:69 and a weight average molecular weight in terms of polystyrene is 20,000), 11.1 g of dipentaerythritol hexaacrylate, 2.2 g of 2-methyl-(4-methylthiophenyl)-2-morpholino-1-propan-1-one, 1.1 g of 2,4-diethylthioxantone, 0.4 g of 3-methacryloxypropyl trimethoxysilane, and 5.5 g of propyleneglycol monomethyl ether acetate were mixed to prepare a composition for forming a decoration layer.

### Synthesis Example 1: Synthesis of Acryl-Based Copolymer

A monomer mixture of 95 parts by weight of n-butylacrylate and 5 parts by weight of 4-hydroxybutylacrylate was introduced into an 1 L reactor with nitrogen gas blowed and a refrigerator to easily regulate its temperature, and then 400 parts by weight of ethylacetate as a solvent was added thereto. Next, nitrogen gas was purged for 1 hour to remove oxygen, and then the temperature was maintained at 62° C. After the mixture was uniformly mixed, 0.07 parts by weight of azobisisobutyronitrile (AIBN) as a reaction initiator was added thereto and then allowed to react for about 8 hours, to prepare an acryl-based copolymer having a weight average molecular weight of 1,500,000.

### Synthesis Example 2: Synthesis of Acryl-Based Copolymer

An acryl-based copolymer having a weight average molecular weight of 1,000,000 was prepared in the same manner as in Synthesis Example 1, except for using 99 parts by weight of 2-ethylhexyl acrylate and 1 part by weight of 4-hydroxybutylacrylate as monomers.

### Synthesis Example 3: Synthesis of Acryl-Based Copolymer

A monomer mixture of 95 parts by weight of n-butylacrylate and 5 parts by weight of 4-hydroxybutylacrylate was introduced into an 1 L reactor with nitrogen gas blowed and a refrigerator to easily regulate its temperature, and then 400 parts by weight of ethylacetate as a solvent was added thereto. Next, nitrogen gas was purged for 1 hour to remove oxygen, and then the temperature was maintained at 62° C. After the mixture was uniformly mixed, 0.07 parts by weight of azobisisobutyronitrile (AIBN) as a reaction initiator was added thereto and then allowed to react for about 4 hours, to prepare an acryl-based copolymer having a weight average molecular weight of 500,000.

### Preparation Example 3: Preparation of Pressure-Sensitive Adhesive Composition

0.05 parts by weight of an adduct of trimethylolpropane and xylene diisocyanate (XDI) was mixed with 100 parts by weight of the acryl-based copolymer of the Synthesis Example 1 to prepare a pressure-sensitive adhesive composition. The pressure-sensitive adhesive composition was mixed with ethyl acetate solvent so as to have a solid content of 20% by weight.

### Preparation Example 4: Preparation of Pressure-Sensitive Adhesive Composition

0.05 parts by weight of an adduct of trimethylolpropane and xylene diisocyanate (XDI) was mixed with 100 parts by weight of the acryl-based copolymer of the Synthesis Example 2 to prepare a pressure-sensitive adhesive composition. The pressure-sensitive adhesive composition was mixed with ethyl acetate solvent so as to have a solid content of 20% by weight.

### Preparation Example 5: Preparation of Pressure-Sensitive Adhesive Composition

0.05 parts by weight of an adduct of trimethylolpropane and xylene diisocyanate (XDI) was mixed with 100 parts by weight of the acryl-based copolymer of the Synthesis Example 3 to prepare a pressure-sensitive adhesive composition. The pressure-sensitive adhesive composition was mixed with ethyl acetate solvent so as to have a solid content of 20% by weight.

### Preparation Example 6: Preparation of Pressure-Sensitive Adhesive Composition

0.1 parts by weight of an adduct of trimethylolpropane and xylene diisocyanate (XDI) was mixed with 100 parts by weight of the acryl-based copolymer of the Synthesis Example 1 to prepare a pressure-sensitive adhesive composition. The pressure-sensitive adhesive composition was mixed with ethyl acetate solvent so as to have a solid content of 20% by weight.

### Examples 1 to 9 and Comparative Examples 1 to 5: Manufacture of Optical Laminate

A decoration layer was formed on the surface opposite to the hard coating layer of the hard coating film of the Preparation Example 1 using the composition for forming a decoration layer of the Preparation Example 2 as follows.

The composition for forming a decoration layer was coated by a spin coating method on the surface opposite to the hard coating layer of the hard coating film, and then placed on a heating plate and kept at a temperature of 100° C. for 3 minutes to form a thin film. Subsequently, a photomask having a pattern was laid on the thin film, followed by UV irradiation. At this time, an 1 KW high pressure mercury lamp having all of g, h, i rays was used as a UV source, and the irradiation intensity was 100 mJ/cm². The UV-irradiated thin film was immersed in a KOH aqueous developing solution having pH of 10.5 so as to be developed. The thin film-coated hard coating film was washed with distilled water, dried with nitrogen gas, and heated in a heating oven at 150° C. for 20 minutes, to form a decoration layer.

At this time, the step height of the decoration layer was controlled as shown in the following Table 1.

Further, each of the pressure-sensitive adhesive compositions of the Preparation Examples 3 to 6 was coated on a releasing agent-coated release film, and dried at 100° C. for 3 to 5 minutes, to prepare a pressure-sensitive adhesive layer having a thickness of 25 μm or 50 μm.

Next, the decoration layer-formed surface of the hard coating film and the pressure-sensitive adhesive layer were attached using a roll bonding machine to prepare an optical laminate.

At this time, the thickness of the pressure-sensitive adhesive layer was controlled as shown in the following Table 1.

In addition, the stress relaxation parameter of the pressure-sensitive adhesive layer defined by [0.1 sec G(t)−300 sec G(t)]/0.1 sec G(t) was controlled as shown in the following Table 1 using the pressure-sensitive adhesive compositions of the Preparation Examples 3 to 6.

From the thickness of the pressure-sensitive adhesive layer, the step height of the decoration layer, and the stress relaxation parameter of the pressure-sensitive adhesive layer defined by [0.1 sec G(t)−300 sec G(t)]/0.1 sec G(t), the step height follow-up factor (Y) of the pressure-sensitive adhesive layer was calculated according to the following mathematical formula 1. The results are shown in the following Table 1.

step height follow-up factor (Y)=(a/b)×c [Mathematical Formula 1]

wherein,

a represents a thickness of the pressure-sensitive adhesive layer,

b represents a step height of the decoration layer, and

c represents a stress relaxation parameter of the pressure-sensitive adhesive layer, which is defined by [0.1 sec G(t)−300 sec G(t)]/0.1 sec G(t).

TABLE 1

| | Pressure-sensitive | | | | |
|---|---|---|---|---|---|
| | Adhesive | a | b | | |
| | Composition | (μm) | (μm) | c | Y |
| Example 1 | Preparation | 50 | 6 | 0.72 | 6.0 |
| | Example 3 | | | | |
| Example 2 | Preparation | 50 | 12 | 0.72 | 3.0 |
| | Example 3 | | | | |
| Example 3 | Preparation | 50 | 25 | 0.72 | 1.4 |
| | Example 3 | | | | |
| Example 4 | Preparation | 50 | 25 | 0.65 | 1.3 |
| | Example 4 | | | | |
| Example 5 | Preparation | 50 | 25 | 0.53 | 1.1 |
| | Example 5 | | | | |
| Example 6 | Preparation | 25 | 6 | 0.53 | 2.2 |
| | Example 5 | | | | |
| Example 7 | Preparation | 25 | 12 | 0.72 | 1.5 |
| | Example 3 | | | | |
| Example 8 | Preparation | 25 | 12 | 0.65 | 1.4 |
| | Example 4 | | | | |
| Example 9 | Preparation | 25 | 12 | 0.72 | 1.5 |
| | Example 3 | | | | |
| Comparative | Preparation | 50 | 25 | 0.45 | 0.9 |
| Example 1 | Example 6 | | | | |
| Comparative | Preparation | 50 | 28 | 0.53 | 0.9 |
| Example 2 | Example 5 | | | | |
| Comparative | Preparation | 25 | 12 | 0.45 | 0.9 |
| Example 3 | Example 6 | | | | |
| Comparative | Preparation | 25 | 25 | 0.72 | 0.7 |
| Example 4 | Example 3 | | | | |
| Comparative | Preparation | 25 | 25 | 0.53 | 0.5 |
| Example 5 | Example 5 | | | | |

### Experimental Example 1:

The properties of the optical laminates prepared in the Examples and Comparative Examples were measured by the following methods. The results are shown in the following Table 2.

### (1) Adhesive Force

The pressure-sensitive adhesive layer was transferred to a 38 μm PET film and cut into a size of 25 mm×100 mm, followed by peeling the release film. After that, it was laminated on a cover window in a pressure of 0.25 MPa and autoclave-treated (5 atm, 50° C., 20 min), to give a sample.

After the sample was allowed to stand for 24 hours under the condition of 23° C., 50%RH, the pressure-sensitive adhesive layer was peeled in a peeling rate of 300 mm/min and peeling angle of 180° using the universal testing machine (UTM, Instron) so as to measure the adhesive force. At this time, the measurement was performed under the condition of 23° C., 50%RH.

### (2) Degree of Bubble Occurrence

Appearance before/after the autoclave treatment (5 atm, 50° C., 20 min) was observed using an optical microscope, and the degree of bubble occurrence was evaluated based on the following evaluation criteria.

<Evaluation Criteria>

∘: No bubble before the autoclave treatment

Δ: bubbles occur slightly before the autoclave treatment, but disappear after the autoclave treatment

x: bubbles occur before the autoclave treatment, and do not disappear after the autoclave treatment

### (3) Bending Resistance

The bending resistance was evaluated based on the following evaluation method and criteria.

<Evaluation Method>

Evaluation standard: IEC 62715

Evaluation equipment: Tension-free U-shape Folding Test Machine for Planar Materials (DLDMLH-FS)

Equipment manufacturer: YUASA SYSTEM (Japan)

Evaluation condition: 60° C., 90% RH/50,000 times (bended so as to make the side of the hard coating layer folded inward)

<Evaluation Criteria>

∘: No defect such as bubble, peeling, or crack in the optical laminate

Δ: Slight defects are observed with naked eyes in the optical laminate

x: Obvious defects are observed with naked eyes in the folded portion of the optical laminate

TABLE 2

| | Adhesive | Degree of bubble | Bending |
|---|---|---|---|
| | force | occurrence | resistance |
| Example 1 | 31 | ∘ | ∘ |
| Example 2 | 31 | ∘ | ∘ |
| Example 3 | 31 | ∘ | ∘ |
| Example 4 | 27 | ∘ | ∘ |
| Example 5 | 19 | Δ | ∘ |
| Example 6 | 7 | ∘ | ∘ |
| Example 7 | 18 | ∘ | ∘ |
| Example 8 | 15 | ∘ | ∘ |
| Example 9 | 7 | Δ | ∘ |
| Comparative | 15 | x | x |
| Example 1 | | | |
| Comparative | 19 | x | x |
| Example 2 | | | |
| Comparative | 6 | x | x |
| Example 3 | | | |
| Comparative | 18 | x | x |
| Example 4 | | | |
| Comparative | 7 | x | x |
| Example 5 | | | |

As shown in Table 2, in the case of the optical laminates of Examples 1 to 9 according to the present invention having a step height follow-up factor (Y) of 1 or more, it was confirmed that the adhesive force was excellent, little bubbles occurred, and bending resistance was excellent under high-temperature high-humidity condition. On the other hand, in the case of the optical laminates of Comparative Examples 1 to 5 having a step height follow-up factor (Y) less than 1, it was confirmed that the degree of the occurrence of bubbles was high, and bending resistance was lowered under high-temperature high-humidity condition.

Although specific parts of the present invention have been described in detail, it will be apparent to those skilled in the art that these specific descriptions are merely a preferred embodiment and that the scope of the present invention is not limited thereto. In addition, those skilled in the art will appreciate that various applications and modifications can be made without departing from the scope of the invention based on the description above.

Therefore, the substantial scope of the present invention is to be defined by the appended claims and equivalents thereof.

1. An optical laminate comprising a cover window, a decoration layer, and a pressure-sensitive adhesive layer,
wherein the pressure-sensitive adhesive layer has a step height follow-up factor (Y) defined by the following mathematical formula 1 of 1 or more:
step height follow-up factor (Y)=(a/b)×c [Mathematical Formula 1]
wherein,
a represents a thickness of the pressure-sensitive adhesive layer,
b represents a step height of the decoration layer, and
c represents a stress relaxation parameter of the pressure-sensitive adhesive layer, which is defined by [0.1 sec G(t)−300 sec G(t)]/0.1 sec G(t).

2. The optical laminate according to claim 1, wherein the pressure-sensitive adhesive layer has a step height follow-up factor (Y) of 1 to 50.

3. The optical laminate according to claim 1, wherein the cover window is a hard coating film or a glass substrate.

4. The optical laminate according to claim 1, wherein the pressure-sensitive adhesive layer has an adhesive force of 5 N/25 mm or more to an adherend.

5. The optical laminate according to claim 4, wherein the adherend is corona-treated, plasma-treated, or primer-treated.

6. The optical laminate according to claim 1, wherein the pressure-sensitive adhesive layer is corona-treated or plasma-treated.

7. A flexible display comprising the optical laminate of claim 1.

8. The flexible display according to claim 7, further comprising an optical layer laminated on the surface of the pressure-sensitive adhesive layer of the optical laminate.

9. The flexible display according to claim 8, wherein the optical layer is at least one selected from the group consisting of a polarizing plate, a touch sensor, and an anti-scattering film.

10. The flexible display according to claim 9, wherein the polarizing plate comprises an elongation-type or coating-type polarizer.

11. A flexible display comprising the optical laminate of claim 2.

12. A flexible display comprising the optical laminate of claim 3.

13. A flexible display comprising the optical laminate of claim 4.

14. A flexible display comprising the optical laminate of claim 5.

15. A flexible display comprising the optical laminate of claim 6.

16. The flexible display according to claim 11, further comprising an optical layer laminated on the surface of the pressure-sensitive adhesive layer of the optical laminate.

17. The flexible display according to claim 12, further comprising an optical layer laminated on the surface of the pressure-sensitive adhesive layer of the optical laminate.

18. The flexible display according to claim 13, further comprising an optical layer laminated on the surface of the pressure-sensitive adhesive layer of the optical laminate.

19. The flexible display according to claim 14, further comprising an optical layer laminated on the surface of the pressure-sensitive adhesive layer of the optical laminate.

20. The flexible display according to claim 15, further comprising an optical layer laminated on the surface of the pressure-sensitive adhesive layer of the optical laminate.
